(19) United States
(12) Patent Application Publication
(10) Pub. No.: US 2012/0116983 A1
(43) Pub. Date: May 10, 2012

(54) SYSTEM AND METHOD FOR REAL ESTATE INVENTORY MANAGEMENT

(76) Inventors: Steve Mak, Toronto (CA); Michael Buenaventura, Toronto (CA); Winston Mak, Toronto (CA); Matthys Van Vuuren, Toronto (CA)

(21) Appl. No.: 12/940,723

(22) Filed: Nov. 5, 2010

(51) Int. Cl. G06Q 50/00

(52) U.S. Cl. 705/314

(57) ABSTRACT

A system and method of real estate inventory management includes providing, to a client system, data identifying one or more units of real estate that are available for sale; receiving a reservation request identifying a unit that is available for sale; receiving, at the server system, purchasing data for a reservation fee for the identified unit of real estate; processing a deposit in the amount of the reservation fee for the identified of real estate using the purchasing data; verifying that the deposit for the identified unit record processed; and updating the reservation status of the identified unit of real estate to indicate that the unit of real estate is not available for sale.

### FIELD

The described embodiments relate to systems and methods for inventory management and, in particular, to systems and methods for real estate inventory management.

### BACKGROUND

Buyers engaged in the process of purchasing real estate (e.g. condominiums, pre-constructions) are faced with a daunting array of choices from prices, locations, features and finishes to developer and builder reputations and experiences. Developers and builders typically have to set up a physical sales centre in proximity to a pre-construction project to provide buyers with information about the pre-construction project, and to solicit and execute sales. Project specific details, features, available inventory and unit specific pricing information may only be available at sales centers during the hours of operations. However, if a buyer is not able to visit the sales centre it may be inconvenient to obtain information and purchase a unit of real estate.

Known systems and methods for real estate purchase may not have up to date inventory, pricing and information on each project. For example, builders may manage their inventory with an offline spreadsheet mechanism. Printed price and inventory lists are distributed to sales representatives that work at sales centers. The offline approach may create opportunities for human error, such as for example during sales events where hundreds of people attend for the chance to purchase. These supplied price and inventory printouts used by sales staffs may not be updated in real-time and new updated lists may only be provided periodically.

Known systems and methods for real estate purchase may not provide effective communication between builders and buyers and may delay responses to buyer requests for information or purchasing. Response rates to requests or questions may be delayed unless the buyer physically visits the sales centers during their hours of operation.

Known systems and methods for real estate purchase may not provide comparative market analysis reports to buyers, and may not educate buyers on comparables, area amenities, and pricing trends in the immediate areas. Known systems and methods for real estate purchase may result in inefficiencies with costs associated with marketing, signage, time, labor, and coordination. Further, developers and builders may be required to use a brokerage for pre-construction sales resulting in increased cost.

### SUMMARY

In a first aspect, some embodiments of the invention provide a method of operating a real estate inventory management system. The real estate inventory management system is configured to interface with a first client system. The method includes establishing a database of unit records. The database includes at least one unit record associated with a unit of real estate. Each unit record has an identifier for the unit of real estate associated therewith. Each unit record has a reservation status field indicating whether the unit of real estate associated therewith is available for sale. The method includes storing the database in a memory. The method includes identifying in the database a subset of unit records. The subset of unit records includes at least a first unit record having a reservation status field which indicates that the unit of real estate associated therewith is available for sale. The method includes providing, to the first client system, data identifying the subset of unit records, and receiving, from the first client system, a reservation request identifying a first selected unit record of the subset of unit records. The first selected unit record has a reservation status field indicating that the unit of real estate associated therewith is available for sale. The method includes receiving, from the first client system, purchasing data for a reservation fee for the unit of real estate associated with the first selected unit record, and receiving, from the first client system, authorization to obtain a deposit in the amount of the reservation fee for the unit of real estate associated with the first selected unit record. The method includes processing the authorization using the purchasing data to obtain the deposit, and verifying thereafter that the deposit for the unit of real estate associated with the first selected unit record processed is correct. The method includes updating the reservation status field of the first selected unit record to indicate that the unit of real estate associated therewith is not available for sale.

In a feature of that aspect of the invention, the method for real estate inventory management further includes establishing project records, including at least one project record associated with a real estate project. Each real estate project including at least one unit of real estate. Each project record has an identifier for the real estate project associated therewith. The method includes storing the project records in the memory. The method includes linking, in the memory, each real estate project record to at least one unit record associated with a unit of real estate included in the real estate project associated with the real estate project record. The method includes providing, to a client system, data identifying one or more real estate projects associated with project records, and receiving in return a request identifying a real estate project associated with a first selected project record. The method includes providing, to the client system, data identifying one or more unit records linked to the first selected project record.

In another feature, each unit record includes a builder identification field for storing data related to a builder, and the method includes transmitting a deposit confirmation to the builder using the builder identification field of the first selected unit record.

In still another feature, the method for real estate inventory management that further includes establishing customization records identifying available finishings and upgrades for units of real estate associated with unit records. The method includes storing the customization records in the memory. The method includes linking the first unit record to at least one customization record. The method includes providing, to the client system, data identifying the available finishings and upgrades of the customization record, and receiving in return a customization request identifying at least one of the available furnishings and upgrades, and storing the customization request in the memory.

In another feature, each unit record includes a purchase price field identifying a base price for the unit of real estate, each customization record includes a price field identifying prices of the available finishings and upgrades, and the method further includes calculating a purchase price for the first selected unit record using the base price and the price of the at least one of the available furnishings and upgrades identified in the customization request, and then storing the purchase price in the memory.

In still another feature, the method of operating a real estate inventory management system further includes receiving a request to add a unit of real estate. The request includes data related to the unit of real estate. The method includes generating a unit record for the unit of real estate, that unit record including data from the request to add the unit of real estate, and then storing the unit record in the database in the memory.

In another feature, the method of operating a real estate inventory management system further includes receiving a request to add a real estate project. The request includes data related to the real estate project. The method includes generating a real estate project record for the real estate project that includes the data related to the real estate project of the request, and then storing the real estate project record in the memory.

In still another feature, the method of operating a real estate inventory management system includes receiving a request to add a unit of real estate to the real estate project, that request including data identifying the unit of real estate. The method includes generating a unit record for the unit of real estate that includes data from the request to add the unit of real estate to the project, storing the unit record in the memory, and linking the project record to the unit record in the memory.

In another feature of that aspect of the invention, the method of operating a real estate inventory management system includes receiving a registration request from a builder that includes data identifying the builder. The method includes linking the data identifying the builder to at least one of the unit records in the memory.

In still another feature, the method of operating a real estate inventory management system includes receiving a request to add a unit of real estate from the builder, that request including data related to the unit of real estate. The method includes generating a unit record for the unit of real estate that includes the data related to the unit of real estate and a builder identification field storing the data identifying the builder, and then storing the unit record in the memory.

In even still another features, the reservation request is received from a buyer and the method further includes receiving a registration request from the buyer including data identifying the buyer. The method includes linking the first selected unit record to the data identifying the buyer.

In another aspect, some embodiments of the invention provide a system for real estate inventory management including a database of unit records. The database includes at least one unit record associated with a unit of real estate. Each unit record has an identifier for the unit of real estate associated therewith, and has a reservation status field indicating whether the unit of real estate associated therewith is available for sale. The system includes a memory configured to store the database. The system includes a unit management module configured to provide, to a client system, data identifying the subset of unit records. The system includes a reservation request module configured to receive, from the client system, a reservation request identifying a first selected unit record of the subset of unit records. The first selected unit record has a reservation status field whose contents indicate whether the unit of real estate associated therewith is available for sale. The system includes a reservation purchasing module configured to receive, from the client system, purchasing data for a reservation fee for the unit of real estate associated with the first selected unit record, and authorization to obtain a deposit in the amount of the reservation fee for the unit of real estate associated with the first selected unit record. The system includes a deposit processing module configured to process the authorization using the purchasing data to obtain the deposit and to verify that the deposit for the unit of real estate associated with the first selected unit record processed correctly. The unit management module is further configured to then update the reservation status field of the first selected unit record to indicate that the unit of real estate associated therewith is not available for sale.

In another feature of that aspect of the invention, the database includes project records. The project records include at least one project record associated with a real estate project. Each real estate project includes at least one unit of real estate. Each project record has an identifier for the real estate project associated therewith. The memory is further configured to store each real estate project record with a unit record of a unit of real estate of that real estate project. The system includes a project management module configured to provide, to a client system, data identifying one or more real estate projects associated with project records. The project management module is configured to receive a request identifying a real estate project associated with a first selected project record. The project management module is further configured to provide, to the client system, data identifying one or more unit records linked to the first selected project record.

In another feature, each unit record includes a builder identification field for storing data related to a builder. The system includes a notification module configured to transmit a deposit confirmation to the builder using the builder identification field of the first selected unit record.

In another feature, there is a customization module configured to store customization records identifying available finishings and upgrades for units of real estate, and to link at least one unit record of the one or more unit records to at least one customization record. The customization module is configured to provide, to the client system, data identifying the available finishings and upgrades of at least one customization record. The customization module is configured to receive, from the client system, a customization request identifying at least one of the available furnishings and upgrades. The customization module is configured to store the customization request. The reservation request module is further configured to receive a reservation request identifying a unit record linked to at least one customization record.

In another feature, each unit record includes a purchase price field identifying a base price for the unit of real estate. Each customization record identifies prices of the available finishings and upgrades. The system further includes a purchase price calculation module configured to calculate a purchase price for the identified unit record using the base price and the price of the at least one of the available furnishings and upgrades identified in the customization request, and store the purchase price in the memory.

In another feature, the unit management module is further configured to receive a request to add a unit. The request includes data related to the unit of real estate. The unit management module is configured generate a unit record for the unit, the unit record including data from the request to add the unit of real estate. The unit management module is configured to store the unit record in the memory.

In another feature, the real estate project management module is further configured to receive a request to add a real estate project, the request including data related to the real estate project. The real estate project management module is further configured to generate a real estate project record for the project. The project record includes the data related to the real estate project of the request. The real estate project management module is further configured to store the real estate project record in the memory.

In another feature, the unit management module is further configured to receive a request to add a unit of real estate to the real estate project. The request includes data identifying the unit of real estate. The unit management module is further configured to generate a unit record for the unit of real estate. The unit record includes data from the request to add the unit of real estate to the project. The unit management module is further configured to store the unit record in the memory, and link the project record to the unit record in the memory.

In another feature, there is a registration module configured to receive a registration request from a builder comprising data identifying the builder. The registration module is configured to link the data identifying the builder to at least one of the unit records in the memory.

In another feature, the unit management module is further configured to receive a request to add a unit of real estate from the builder. The request includes data related to the unit of real estate. The unit management module is further configured to generate a unit record for the unit. The unit record includes data from the request to add the unit of real estate and a builder identification field for storing data identifying the builder. The unit management module is further configured to store the unit record in the memory.

In another feature, the reservation request is received from a buyer. The system further includes a registration module configured to receive a registration request from the buyer comprising data identifying the buyer, and link the first selected unit record to the data identifying the buyer. In another feature, the units of real estate include units of pre-construction real estate.

### BRIEF DESCRIPTION OF THE DRAWINGS

For a better understanding of the example embodiments described herein, and to show more clearly how they may be carried into effect, reference will now be made, by way of example, to the accompanying drawings in which:

FIG. 1 is a block diagram of components interacting with a real estate inventory management system in accordance with an example embodiment;

FIG. 2 is a block diagram of a system for real estate inventory management in accordance with an example embodiment;

FIG. 3 is a flowchart diagram of a method of operation of a real estate inventory management system in accordance with an example embodiment;

FIG. 4 is a flowchart diagram of a method of operation of a real estate inventory management system in accordance with another example embodiment;

FIG. 5 is a sample screen display of a builder management user interface that interfaces with a real estate inventory management system in accordance with another example embodiment;

FIG. 6 is another sample screen display of a builder management user interface that interfaces with a real estate inventory management system in accordance with another example embodiment;

FIG. 7 is a sample screen display of a builder management user interface for receiving data related to units of real estate in accordance with another example embodiment;

FIG. 8A is a sample screen display of a user interface of a real estate inventory management system for providing data identifying real estate projects in accordance with another example embodiment;

FIG. 8B is another sample screen display of a user interface of a real estate inventory management system for providing data identifying real estate projects in accordance with another example embodiment;

FIG. 9 is a sample screen display of a user interface of real estate inventory management system for providing data related to the identified real estate project in accordance with another example embodiment;

FIG. 10 is a sample screen display of a user interface of a real estate inventory management system for providing data identifying units of real estate that are available for sale in accordance with another example embodiment;

FIG. 11 is a sample screen display of a user interface of a real estate inventory management system for providing an online shopping cart in accordance with another example embodiment;

FIG. 12 is a sample screen display of a user interface of a real estate inventory management system for receiving purchasing data in accordance with another example embodiment;

FIG. 13 is a sample screen display of a user interface of a real estate inventory management system for providing a notification in accordance with another example embodiment; and

FIGS. 14A, 14B, 14C, 14D, 14E, and 14F are sample screen displays of a user interface of a real estate inventory management system for providing customization data in accordance with other exemplary embodiments.

The drawings, described below, are provided for purposes of illustration, and not of limitation, of the aspects and features of various examples of embodiments of the invention described herein. The drawings are not intended to limit the scope of the applicants' teachings in any way. For simplicity and clarity of illustration, elements shown in the figures have not necessarily been drawn to scale. The dimensions of some of the elements may be exaggerated relative to other elements for clarity. Further, where considered appropriate, reference numerals may be repeated among the figures to indicate corresponding or analogous elements.

### DESCRIPTION OF EXEMPLARY EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

The embodiments of the systems and methods described herein may be implemented in hardware or software, or a combination of both. However, these embodiments may be implemented in computer programs executing on programmable computers, each computer including at least one processor, a data storage system (including volatile and non-volatile memory and/or storage elements), and at least one communication interface. For example, the programmable computers may be a server, network appliance, set-top box, embedded device, computer expansion module, personal computer, laptop, personal data assistant, or mobile device. Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication (IPC). In still other embodiments, there may be a combination of communication interfaces.

Each program may be implemented in a high level procedural or object oriented programming or scripting language, or both, to communicate with a computer system. However, alternatively the programs may be implemented in assembly or machine language, if desired. In any case, the language may be a compiled or interpreted language. Each such computer program may be stored on a storage media or a device (e.g. ROM or magnetic diskette), readable by a general or special purpose programmable computer, for configuring and operating the computer when the storage media or device is read by the computer to perform the procedures described herein. The inventive system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product including a physical non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

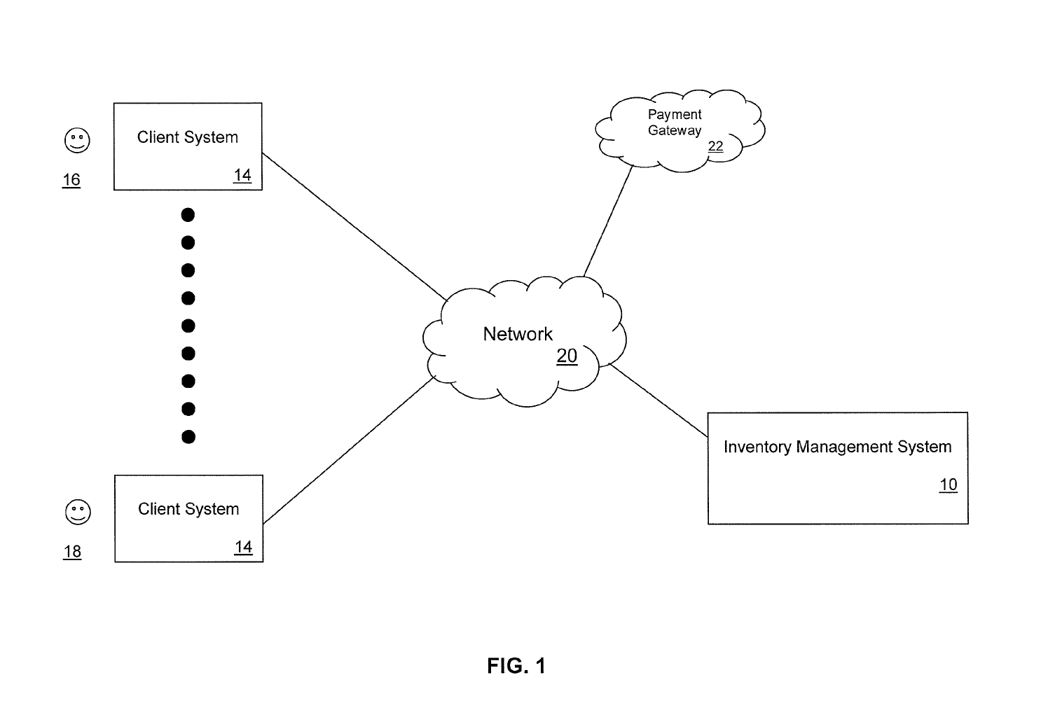

Reference is first made to FIG. 1, which illustrates a block diagram of components interacting with a real estate inventory management system 10 in accordance with an example embodiment. Generally, inventory management system 10 interfaces with a client system 14 to receive from a buyer 16 operating client system 14 a request to reserve for purchase one or more freehold, condominium or pre-construction units offered for sale by a builder 18. For example, inventory management system 10 may interface with client system 14 by serving a webpage to the client system 14. The term builder as used herein may refer to a builder of a real estate construction project, a vendor, a developer, a planner, a designer, an engineer, a building provider, a service provider, an architect, a contractor, an administrator, a manager and the like. Inventory management system 10 provides an escrow deposit service by receiving, from a buyer 16 operating client system 14, a reservation request and a reservation fee as a deposit for a unit of real estate. Inventory management system 10 processes the deposit using payment gateway 22, which may be internal to inventory management system 10 or external and connected thereto via network 20. Inventory management system 10 distributes the reservation fee to the builder 18, a legal representative or another third party operating client system 14. The inventory management system 10 may deduct an administration fee for providing the service to the builder 18. After completion of the reservation process, inventory management system 10 records the reservation and updates unit records to reflect real-time inventory of current units of real estate available for sale.

Inventory management system 10 receives and transmits data via network 20 to one or more client systems 14 operated by a buyer 16 or a builder 18. Inventory management system 10 may optionally use a firewall to provide a secure connection to network 20. Inventory management system 10 may use payment gateway 22 to process deposits using purchasing data receive received from buyer 16 operating client system 14. Inventory management system 10 may distribute a reservation fee to builder 18 directly or via payment gateway 22 and client system 14.

Inventory management system 10 may be a server system that has one or more servers with computing processing abilities and memory such as database(s) or file system(s). Although only one inventory management system 10 is shown for clarity, there may be multiple inventory management systems 10 distributed over a wide geographic area and connected via e.g. network 20. Inventory management system 10 has a network interface for connecting to network 20 in order to communicate with other components and to serve web pages and other computing applications.

Client system 14 may be any networked computing device including a processor and memory, such as a personal computer, workstation, server, portable computer, mobile phone, personal digital assistant, laptop, smart phone, WAP phone, or a combination of these. Client system 14 typically includes one or more input devices, such as a keyboard, mouse, camera, touch screen and a microphone, and also includes one or more output devices such as a display screen and a speaker. Client system 14 has a network interface for connecting to network 20 in order to communicate with other components.

Payment gateway 22 is a server system that provides an e-commerce application service that authorizes payments made using a credit card, a debit card, an electronic payment system, a smart card, a mobile phone and the like. Payment gateway 22 may process real estate related transactions and escrow deposits in accordance with real estate laws of relevant jurisdictions. Payment gateway 22 and inventory management system 10 may encrypt sensitive information, such as credit card numbers, to ensure that information passes securely over network 20. There may be a firewall between payment gateway 22 and network 20. Payment gateway 22 may be integral to and may form part of inventory management system 10, even though they are illustrated in FIG. 1 as separate components.

Network 20 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

Inventory management system 10 permits online reservations for the purchase of units of real estate and provides real-time real estate inventory management. Inventory management system 10 unifies (i.e. collects in one place, and stores in an organized, searchable manner) data received from developers and builders operating client system 14 in relation to freehold, condominium or pre-construction projects in the industry, and allows buyers 16 operating client system 14 to interact with builders 18 directly using a variety of messaging solutions.

For buyers, sales staffs and administrative professionals, inventory management system 10 provides an efficient way to search, locate and compare available units of real estate that meet desired criteria for level of finishes, prestige, price, and location at any time, extending beyond office hours. Reservations can be made around the clock. Inventory management system 10 may be directly connected to computerized reservation systems at builder's sales centers as well as mobile devices (e.g. Blackberry, iPhone and Android mobile phones) connected to network 20 to receive inventory data and transmit notifications.

Inventory management system 10 may streamline the real estate process by centralizing real-time information supplied by builders 18 and may increase sales by making the purchase process more convenient and ensure up-to-date inventory. Inventory management system 10 provides a centralized system for used by investors, developers, government authorities, contractors, and other related industry professionals. Inventory management system 10 provides an escrow service to qualify buyers entering into the sales process with the vendor, developer, builder, and so on.

Inventory management system 10 may provide live video feeds of grand openings, pre-sale or VIP presentations, as well as coverage of information sessions, focus groups, networking events, builder/architect/interior designers and construction perspectives on developments. Inventory management system 10 may provide automated mortgage calculators to comparing effective payments between top financial institutions, development pricing/price lists, floor plans and feature sheets, site assessments and background files. Inventory management system 10 may provide the ability to compare project developments between and within builders via one single standard or format based on provided search criteria.

Inventory management system 10 may provide an online presentation center and provide a visual platform, which buyers 16 operating client system 14 can use to develop, compare, customize, and asses alternative real estate sales opportunities based on their purchase preferences. The solution may shorten the purchasing process and reduce the time buyers spend deliberating with realtors, sales representatives or their associates; attending formal sales events; or remaining on or relying upon waiting lists, with, in some cases, incorrect or out-of-date information.

Inventory management system 10 may incorporate object-oriented image rendering search capabilities. Inventory management system 10 provides a visual perspective of units of real estate (customized using finishings and upgrades in some cases) to help buyers 16 define and rank the priority of those features that are most important to them, and yield an accurate search result based on the finishes or upgrades, or both, that they select in the virtual rooms. This may allow buyers to identify their expectations and to find the most suitable development project that meets their custom requirements. Inventory management system 10 may incorporate object-oriented rendering to improve the placement of new products, finishes, or upgrades selected in the vignette. This allows buyers to start with an empty virtual room, kitchen, or bathroom and add photo-realistic objects into the room with accurate perspectives and camera angles. This provides improved flexibility to place products anywhere within the virtual room to meet buyers' requirements of their dream kitchens and bathrooms and cross search with what developers and builders are actually offering, to create the ideal list of projects for the buyer to consider.

Inventory management system 10 may serve a web browser with a webpage to provide secure or authenticated electronic delivery of information for electronic real estate inventory reservation, interior designing, and purchasing of products relating to e.g. pre-construction, condominium floor plans or house plans. Inventory management system 10 may include a central control unit, a web server that is connected to the network 20 (e.g. internet), and a database stored on memory for managing data including: data concerning the builders or developers, or both, who are registered with the system; floor plans data, which translates directly into inventory levels offered by the builders 18; data relating to finishing materials used throughout the interiors of each property; digitized legal contracts and agreement data provided by builders 18 or their legal counsel in association with every unit of real estate from each builder 18; and data relating to delivering inventory management tools and data to client system(s) 14 (including inventory database systems and mobile devices) of builders 18.

Inventory management system 10 may include a central control unit operable to deliver to buyers, end users, and investors floor plans or materials data, and to receive buyer reservation commitments. Inventory management system 10 may receive as input data floor plans and related data offered directly from the builders or by their agents, and a list of the building materials, including various materials-related data contractually offered by the builder as finishings and upgrades. Inventory management system 10 may deliver to buyers 16, end users, and investors a mechanism to reserve units of real estate online and a preview of their agreement of purchase and sale they will need to sign. Inventory management system 10 may deliver to builders' 18 staff or their designated agent the status of each unit of real estate within their inventory pool, remotely via mobile devices of any sort equipped with Internet access.

As noted herein, inventory management system 10 may include units of real estate of a pre-construction project. Pre-construction units may be dynamic and may be subject to changes or substitutions with the same or higher quality materials, or even with floor plan variations as the builder sees fit. Buyers are not able to see the units physically as they have not yet been constructed, so they would have no access or any form of entry. An online system as provided in one embodiment herein not deprive a buyer of viewing the units of real estate first hand as they have not yet been constructed, whereas for resale, the property exists for inspection.

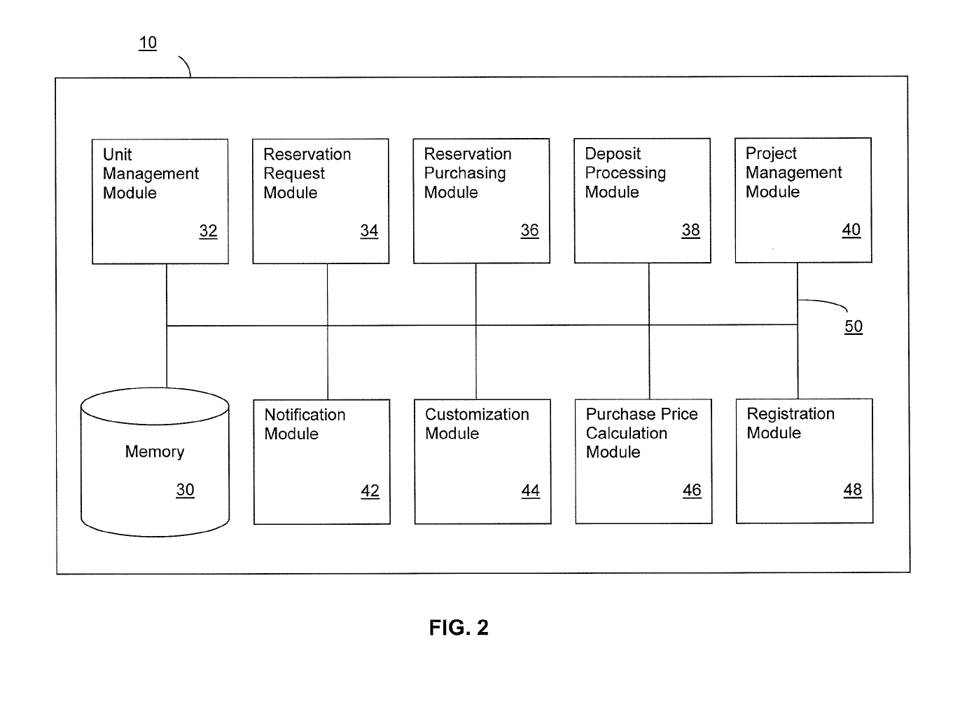

Reference is now made to FIG. 2, which illustrates a block diagram of a real estate inventory management system 10 in accordance with an example embodiment. The example real estate inventory management system 10 includes a memory 30, a unit management module 32, a reservation request module 34, a reservation purchasing module 36, a deposit processing module 38, a project management module 40, a notification module 42, a customization module 44, a purchase price calculation module 46, and a registration module 48.

Memory 30 accepts input data and uses the input data to define and store unit records. Each unit record identifies a unit of real estate to which the unit record relates. A unit record includes a reservation status field indicating (i.e. according to the contents of that field) whether the unit of real estate is available for sale. The reservation status field may indicate that the unit of real estate is “available for sale”, “sold”, “conditionally sold”, “pending verification”, and so on. Memory 30 accepts input data and uses the input data to define and store real estate project records, where each project relates to one or more units of real estate. Memory 30 maintains a mapping system between records and links each real estate project record to unit records that relate to the project. For example, a real estate project such as a pre-construction condominium project, includes units of real estate that are available for sale and memory 30 stores the relationship between the project and units of real estate via linking.

Unit management module 32 is a storage and processing module receives input data from client system 14 and to establish a database of unit records, the database including at least one unit record associated with a unit of real estate, each unit record having an identifier for the unit of real estate associated therewith, each unit record having a reservation status field indicating whether the unit of real estate associated therewith is available for sale. Unit management module 32 stores the database in a memory. Unit management module 32 identifies in the database a subset of unit records, the subset including at least a first unit record having a reservation status field indicating that the unit of real estate associated therewith is available for sale and provides such output to a client system 14. Unit management module 32 identifies the subset of unit records in response to receiving as input data: a search request identifying features of units of real estate such as a location range, price range or desired amenities, a project request, a builder request, and so on. Further, unit management module 32 interacts with other components to verify that a deposit for the unit of real estate identified in a unit record is processed correctly, and, upon receiving such verification as input, modifies the identified unit record to update the reservation status of the identified unit record to indicate that the unit of real estate is no longer available for sale.

In accordance with some embodiments, unit management module 32 has storage and processing capabilities to receive input data including a request to add a new unit of real estate to inventory management system 10. The request includes data related to the unit of real estate including an indication of whether the unit is available for sale. In response to receiving the request, unit management module 32 generates a unit record using the input data and stores the unit record in the memory 30. Unit management module 32 has storage and processing capabilities to receive input data including a request to modify an existing unit record where the request includes data identifying the unit of real estate and the desired modification. In response to receiving such a request, the unit management module 32 locates the unit record that relates to the identified unit of real estate, makes a modification to the located unit record based on the desired modification, and stores the modified unit record in memory 30.

Reservation request module 34 has storage and processing capabilities to receive input data from client system 14. The input data may include a reservation request identifying a first selected unit record of the subset of unit records, the first selected unit record having a reservation status field indicating that the unit of real estate associated therewith is available for sale. In response, reservation request module 34 identifies the first selected unit record and provides the identified unit record to deposit processing module 38. Reservation request module 34 stores data relating to the request in memory 30 for access by other components of the inventory management system 10.

Reservation purchasing module 36 has storage and processing capabilities to receive as input data, from the client system 14, purchasing data for a reservation fee for the unit of real estate associated with the first selected unit record. Reservation purchasing module 36 receives, from the first client system 14, authorization to obtain a deposit in the amount of the reservation fee for the unit of real estate associated with the first selected unit record. Reservation purchasing module 36 stores purchasing data relating to the request in memory 30. In accordance with some embodiments, the reservation purchasing module 36 stores the purchasing data in memory 30.

Deposit processing module 38 has storage and processing capabilities to process the authorization using the purchasing data to obtain the deposit and verify that the deposit for the unit of real estate associated with the first selected unit record processed. Deposit processing module 38 may connect to payment gateway 22 via network 20 to process the authorization by providing the purchasing data to payment gateway 22. Deposit processing module 38 may receive confirmation from the payment gateway 22 that the deposit processed. Deposit processing module 38 may distribute the reservation fee to client system 14 operated by the builder 18 or an authorized agent.

Project management module 40 has storage and processing capabilities to provide to a client system 14 data identifying one or more real estate projects, wherein each of the one or more real estate projects corresponds to a real estate project record. Project management module 40 has storage and processing capabilities to receive as input data a real estate project request identifying a project record, and in response, provide, to the client system 14, data related to the identified real estate project record. Further, project management module 40 has storage and processing capabilities to provide, to the client system 14, data identifying one or more unit records linked to the identified project record, where the unit records include a reservation status indicating that the unit of real estate associated therewith is available for sale. That is, project management module 40 provides data relating to units of real estate that are part of the real estate project and available for sale.

In accordance with some embodiments, project management module 40 has storage and processing capabilities to receive as input a request to add a real estate project, where the request includes data related to the real estate project. In response, project management module 40 generates a real estate project record for the project and store the real estate project record in the memory.

Notification module 42 has storage and processing capabilities to transmit a deposit confirmation to client system 14 operated by the builder 18 using a builder identification field of the identified unit record, upon determining that the deposit for the identified unit record processed.

Customization module 44 has storage and processing capabilities to receive input data relating to finishing and upgrades customization records that identify available finishings and upgrades for units of real estate, and that link at least one of the unit records to at least one customization record. Customization module 44 provides, to the client system 14, data that identifies the available finishings and upgrades of at least one customization record, when the reservation request module 34 receives a reservation request identifying a unit record linked to at least one customization record. Customization module 44 may receive, from the client system 14, a customization request identifying at least one of the available furnishings and upgrades, and may then store the customization request.

Purchase price calculation module 46 has storage and processing capabilities to calculate a purchase price for the selected unit record using a base price and, if applicable, the price of available furnishings and upgrades identified in a customization request. Purchase price calculation module 46 stores the purchase price in the memory. Each unit record includes a purchase price field identifying a base price for the unit of real estate, and each customization record identifies prices of the available finishings and upgrades. Purchase price calculation module 46 uses this data to calculate the purchase price for the selected unit of real estate.

Registration module 48 has storage and processing capabilities to receive a registration request from client system 14 operated by a builder 18, where the request includes data identifying the builder. In response, registration module 48 generates a builder record including a builder identification field for storing the data identifying the builder, and for storing the builder record. Registration module 48 links the builder record to at least one of the unit records in the memory.

In accordance with some embodiments the reservation request receives from client system 14 operated by a buyer 16 a registration request including data identifying the buyer 16. The registration module 48 generates a buyer record including a buyer identification field and stores the buyer record. Deposit processing module 38 verifies that the deposit for the unit of real estate associated with the first selected unit record processed and provides such verification to registration module 48. In response, registration module 48 links the selected unit record to the buyer record upon determining that the deposit for the identified unit record successfully processed. Inventory management system 10 uses the linking to maintain the relationship between the buyer 16 and the unit of real estate reserved for purchase by the buyer 16.

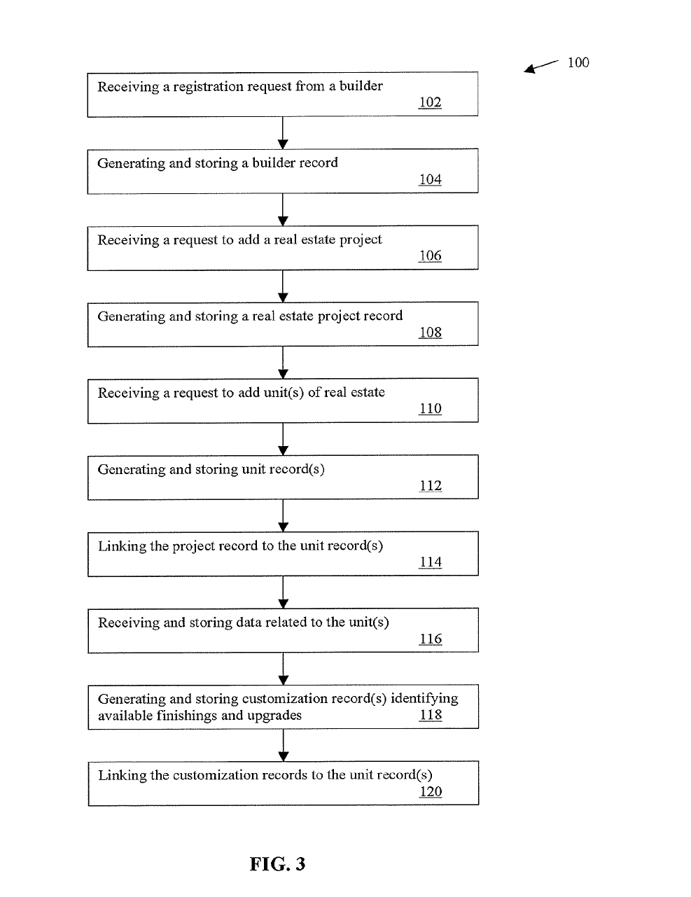

Reference is now made to FIG. 3, which illustrates a flowchart diagram showing steps of a method 100 of operation of a real estate inventory management system in accordance with an example embodiment.

At step 102, real estate inventory management system 10 receives a registration request from client system 14 operated by a builder 18. The registration request includes data identifying the builder 18 such as a username, password, company name, phone number, email address and street address, for example. In response, real estate inventory management system 10 processes the registration and provides as output a confirmed username and password which permits an operator of client system 14 to log in to submit data relating units of real estate that are available for sale and to monitor the status of inventory.

At step 104, real estate inventory management system 10 generates a builder record including a builder identification field in which to store the data identifying the builder.

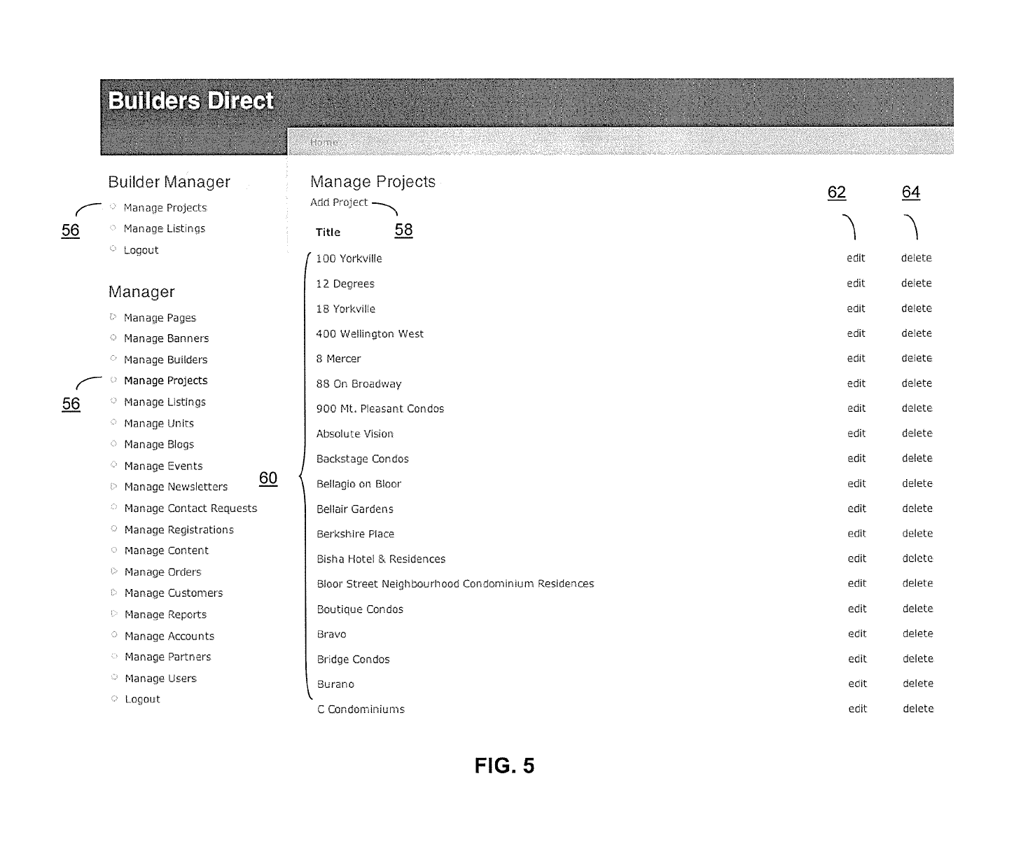

At step 106, real estate inventory management system 10 receives a request to add a real estate project from the builder. The request includes data related to the real estate project. Reference is now made to FIG. 5, which illustrates a sample screen display of a builder management user interface for access to real estate inventory management system 10 in accordance with an example embodiment. The builder management user interface includes a project manager selection tool 56 that provides an interface between client system 14 and real estate inventory management system 10. Project manager selection tool 56 has functions by which client system 14 may submit requests to real estate inventory management system 10 to review, edit 62 and delete 64 current projects 60. An add project tool 58 has functions by which client system 14 may submit a request to add a real estate project to real estate inventory management system 10. Projects may likewise be cancelled or amended as may be appropriate. Builder management user interface provides up to date data relating to a real estate project and processes customization requests for the project data, brochures, images, blue prints, specifications and features.

Referring back to FIG. 3, at step 108, real estate inventory management system 10 generates a real estate project record for the project, where the real estate project record includes data from the request to add the real estate project. Real estate inventory management system 10 stores the real estate project record in the memory, and links the builder record to the project record in the memory 30.

At step 110, real estate inventory management system 10 receives a request to add a unit of real estate, wherein the request includes data identifying the unit of real estate. The request may be specific to a real estate project and/or a builder 18, however, real estate inventory management system 10 may receive a request to add a unit of real estate that is not specific to a project or builder 18.

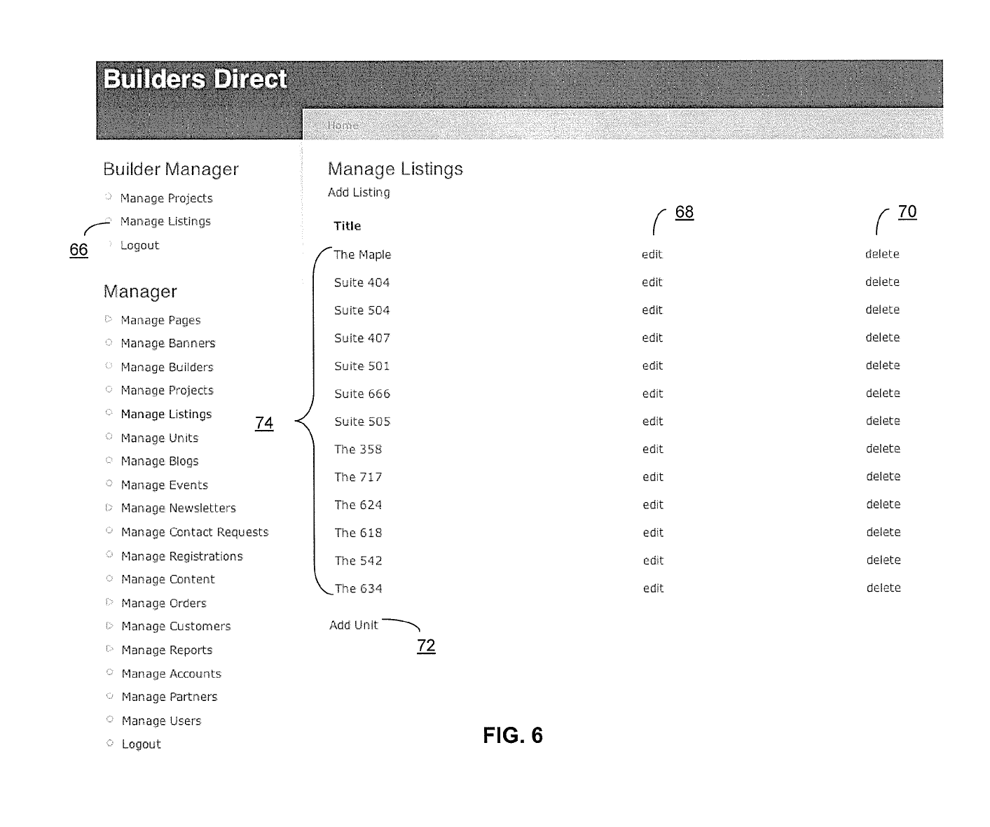

Reference is now made to FIG. 6, which illustrates another sample screen display of a builder management user interface for use by builder to access real estate inventory management system 10. The builder management user interface includes a listing manager selection tool 66 that has functions by which client system 14 may submit requests to review, edit 68 and delete 70 real estate listings 74, where the real estate listings 74 include units of real estate. The add unit tool 72 has functions by which client system 14 may submit a request to add a unit of real estate. Builder management user interface provides up to date data and processes requests for monitoring inventory, adding units of real estate to a project, and customizing the unit data, floor-plans, unit specifications and features.

Referring back to FIG. 3, at step 112, real estate inventory management system 10 generates and stores a unit record for the unit of real estate. The unit record includes data from the request to add the unit of real estate to the project. If the unit of real estate is specific to a project or builder then the unit record may include a project identification field or a builder identification field for storing the data identifying the project and/or builder, respectively.

At step 114, if the unit of real estate is specific to a project then real estate inventory management system 10 links the project record to the unit record in the memory 30. In addition, if the unit of real estate is specific to a builder then real estate inventory management system 10 links the builder record to the unit record in the memory 30.

At step 116, real estate inventory management system 10 receives data relating to units of real estate and to store the received data in the unit records, or be linked thereto. For example, real estate inventory management system 10 has storage and processing capabilities permitting it to receive and to manage data relating to floor plans, specifications, purchase prices, deposit prices, reservation fees, addresses, availability statuses, availability dates, finishings, upgrades, visual models of the unit and/or available finishings and upgrades, and so on.

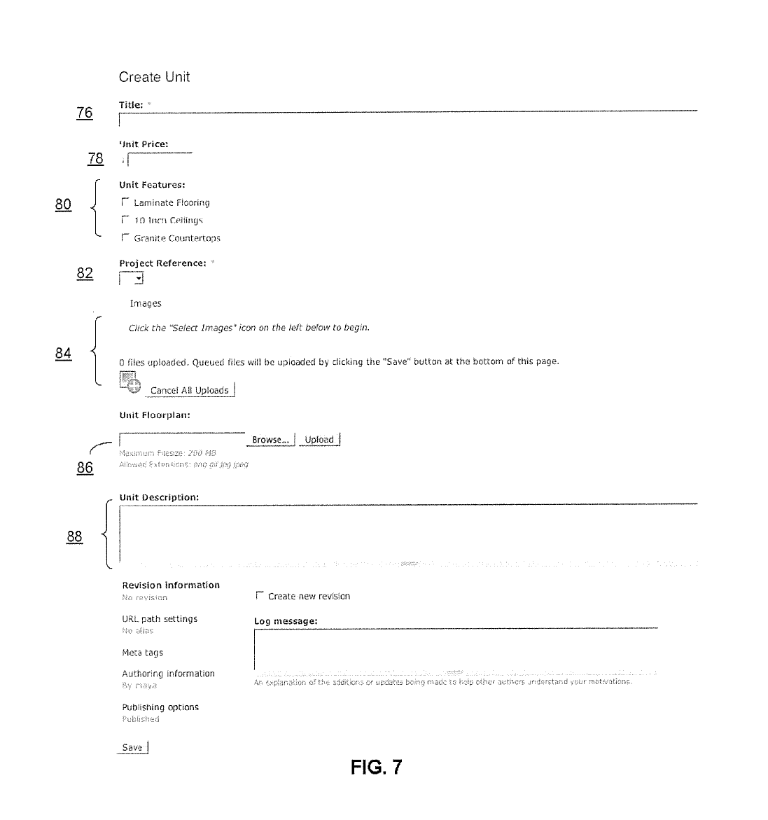

Reference is now made to FIG. 7, which illustrates another sample screen display of a builder management user interface with the memory and processing capabilities to receive, from client system 14, data relating to a unit of real estate and provide such data to real estate inventory management system 10. In this example, the builder management user interface receives from client system 14 a unit title 76, a unit price 78, available finishings and upgrades 80 (e.g., laminate flooring, 10 inch ceilings and granite countertops), a reference to a real estate project 82, images 84, unit floor plan 86, unit description 88, and other data including metatags, URL paths, authoring information, revision information, availability status, and publishing options. Builder management user interface transmit such data to real estate inventory management system 10 for storage and processing by its modules.

At step 118, real estate inventory management system 10 generates and stores customization records identifying available finishings and upgrades for units of real estate. The customization records may include the price of each finishing and upgrades. The customization records may also include visual models of the finishing and upgrades, such as photos, images, 3D models of the finishings and upgrades for virtual positioning within a 3D model of the unit, and so on.

Real estate inventory management system 10 has storage and processing functionality to generate and to store customization records by providing a customizing finishes software application to client system 14 to enable it to receive customization data pertaining to upgrades and finishings. Real estate inventory management system 10 configures different levels of customization for units of real estate, including static customization, semi-customization and full customization. A static customization includes a fixed set of color packages, upgrades and finishings, that cannot be mixed and matched. For example there may be a finite number of packages from which to choose from. A semi-customization may be offered in conjunction with static customization, such as a selection of known upgrades to specific finishings e.g. counter tops to a premium material, faucets, or appliances, for a fixed price that real estate inventory management system 10 interactively updates in real time both visually in the image and in the purchase price for the unit. Full customization may be offered with custom luxury units for example. Real estate inventory management system 10 permits customization from a wide selection of colors and finishes, all tagged and labeled with respective prices while changing the final purchase price for the unit once a selection is received from client system 14. Real estate inventory management system 10 permits full control on the level of customization allowed depending on marketing strategy and so on.

At step 120, real estate inventory management system 10 links the customization records to the applicable unit records for which the finishing and upgrades are available. That way, if a unit of real estate is selected the available finishings and upgrades may be provided to buyers 16.

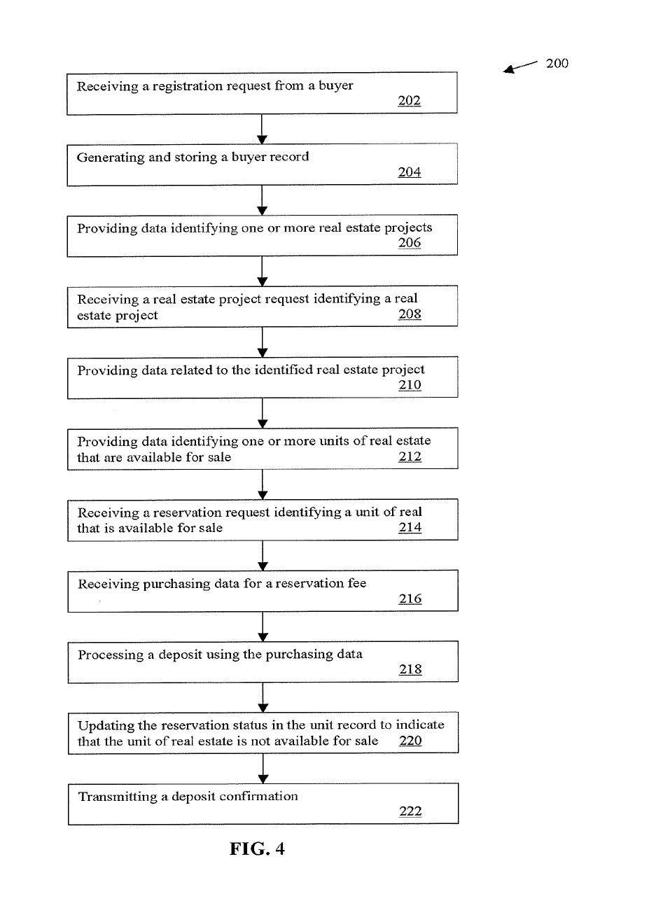

Reference is now made to FIG. 4, which illustrates a flowchart diagram of a method 200 of operation of a real estate inventory management system in accordance with another example embodiment.

At step 202, real estate inventory management system 10 receives a registration request from the buyer. The registration request includes data identifying the buyer such as a username, password, company name, phone number, email address and street address, for example. Optionally, the registration request may also include purchasing data, such as a credit card number, so that when a buyer 16 wants to reserve a unit of real estate then real estate inventory management system 10 can access the purchase information.

At step 204, real estate inventory management system 10 generates and stores a buyer record including a buyer identification field for storing data identifying to the buyer 16 and other buyer related data.

At step 206, real estate inventory management system 10 provides, to a client system 14, data identifying one or more real estate projects. Each of the one or more real estate projects corresponds to a real estate project record. As noted herein, real estate inventory management system 10 stores real estate project records in the memory and links each real estate project record to unit records in the memory. Real estate inventory management system 10 may received data in response to receiving a notification from a selection tool on a user interface on client system 14, from featured projects or through a search request. Real estate inventory management system 10 has sorting functionality to sort the project data by location, price range, availability and other details and provides the sorted data to client system 14.

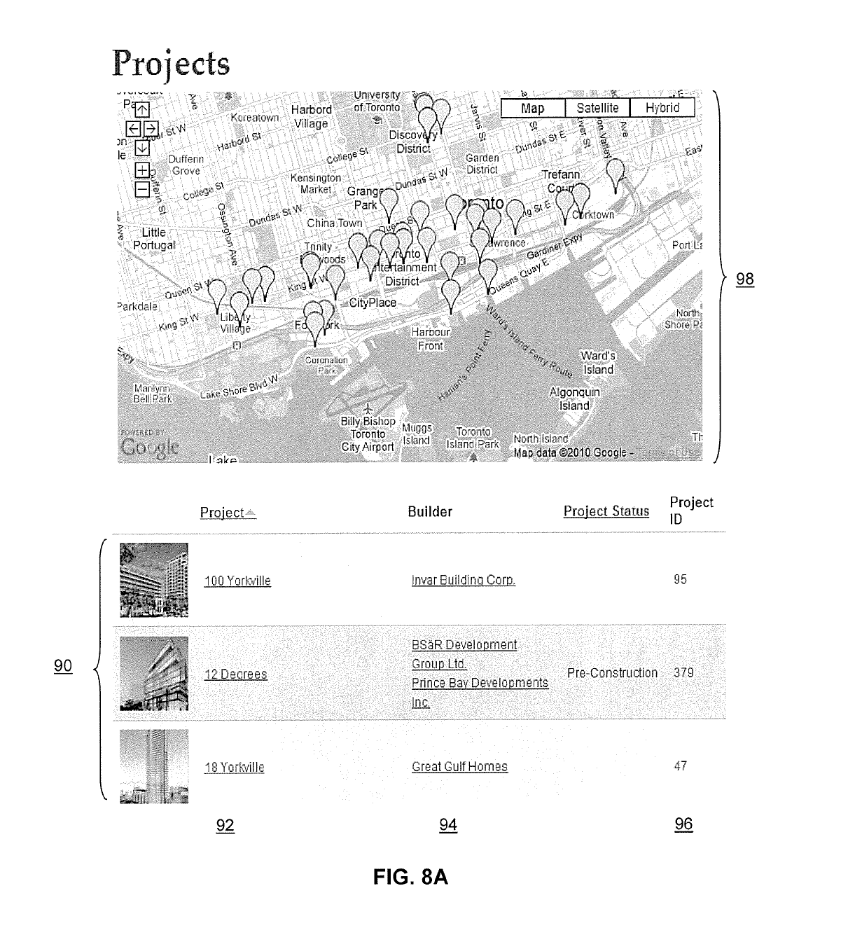

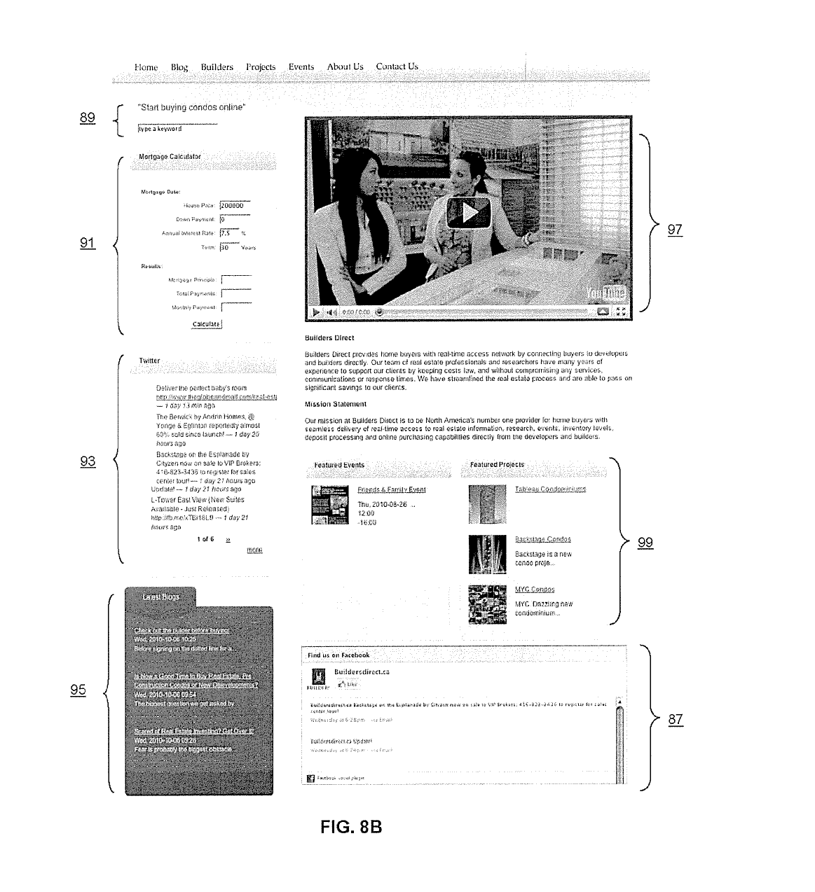

FIG. 8A illustrates a sample screen display of a user interface of real estate inventory management system 10 showing a display of recorded data identifying projects 90 including project titles 92, builder names 94, project statuses 96, and map 98 of project locations. Real estate inventory management system 10 provides additional data about the project in response to receiving a selection of the project title 92, and data about the builder in response to receiving a selection of the builder name 94. FIG. 8B illustrates another sample screen display of a user interface of real estate inventory management system 10 showing a display of recorded data identifying featured projects 90 and a search request 89 (i.e. search box) to receive search input data relating for projects, such as select key words for example. User interface may also provide social networking information regarding projects including a Twitter™ feed 93, blog posts 95, YouTube™ videos and Facebook™ updates 87. User interface may also provide a mortgage calculator tool 91.

At step 208, real estate inventory management system 10 receives a real estate project request identifying a project record. Referring back to FIGS. 8A and 8B, real estate inventory management system 10 may receive the project request in response to a user selecting the project title 92 and featured projects 90, or in response to receiving search input data via a search request 89.

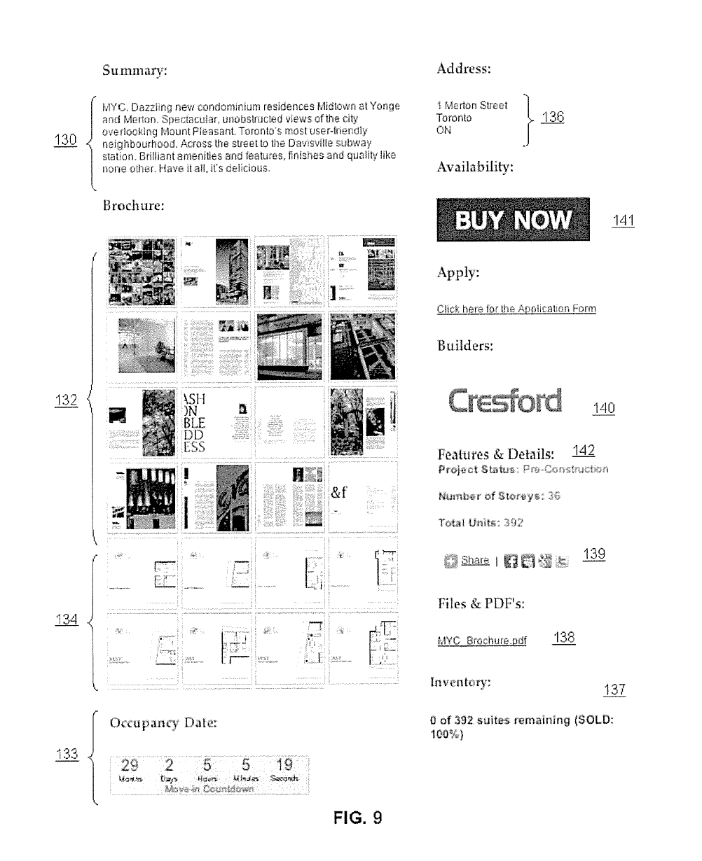

At step 210, real estate inventory management system 10 provides, to the client system 14, data related to the identified real estate project record. For example, once a project selection has been made, the potential buyer 16 may be directed to a project main page where all the project details are listed. The project main page may indicate unit availability in percentages. The project main page may contain a BUY NOW button 141 (FIG. 9). In response to receiving a selection of the BUY NOW button 141, real estate inventory management system 10 will compute and provide data identifying all available units within the real estate project that are still available for sale.

Reference is now made to FIG. 9, which illustrates a sample screen display of a user interface of real estate inventory management system 10 showing recorded data related to the identified real estate project record such as a project summary 130, images 132 for the project, inventory data (including a percentage of sold or available units) 137, occupancy date 133, blueprint and floor plans 134, project address 136, project builder 140, project features and details 142, and a project brochure 138. The user interface further shows a BUY NOW button 141 for receiving a request to reserve for purchase a unit of real estate and share button 139 for sending the data related to the real estate project to third parties via social networking sites. Real estate inventory management system 10 manages and stores data related to the project, including data uploaded by a client system 14 operated by a builder 18.

At step 212, in response to receiving a request from client system 14, real estate inventory management system 10 provides to the client system 14 data identifying one or more unit records that are available for sale. As noted herein, real estate inventory management system 10 stores unit records in memory. Each unit record identifies a unit of real estate and includes a reservation status field for indicating whether the unit of real estate is available for sale. In accordance with some embodiments, units may be specific to a project or builder and real estate inventory management system 10 computes and provides units of real estate related to unit records linked to the identified project record or builder.

Client system 14 provides data to client system 14 listing units of real estate that are available for sale and receives a request to reserve such units for purchase. Real estate inventory management system 10 provides data identifying one or more unit records in response to receiving a search request 89 (FIG. 8B), project selection, or builder selection, for example. For example, real estate inventory management system 10 computes and provides data identifying one or more unit records in response to receiving a searching request 89 for a unit of real estate within a price range and a location range from client system 14.

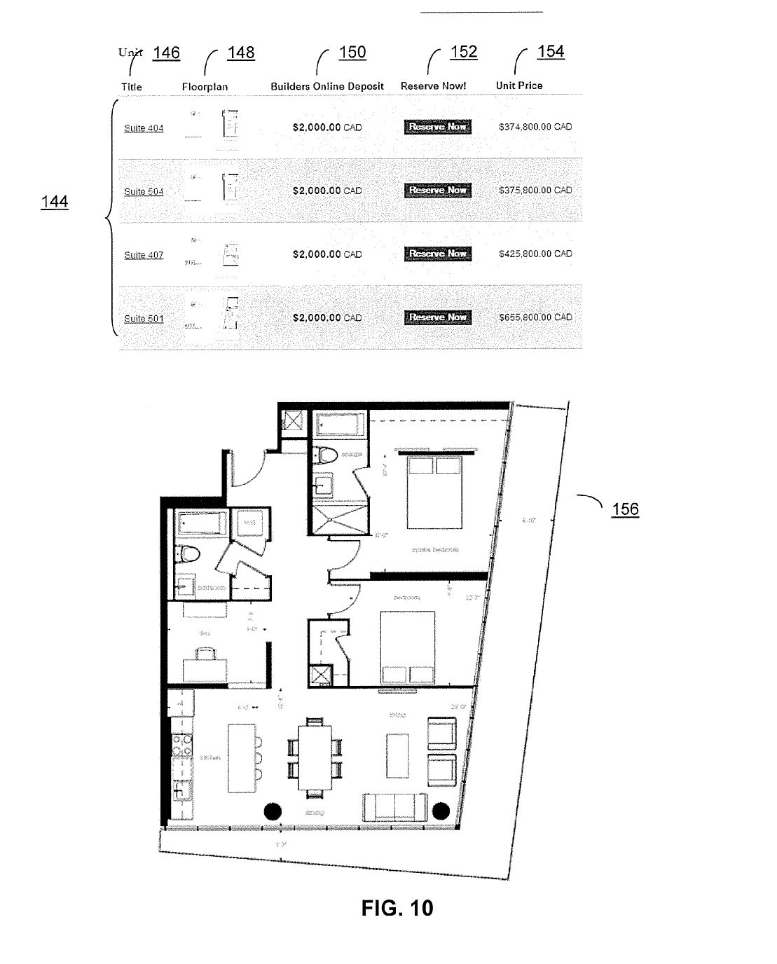

Reference is now made to FIG. 10, which illustrates a sample screen display of a user interface of real estate inventory management system 10 that provides data identifying units of real estate 144 that are available for sale. The data includes unit titles 146, floor plans 148/156, reservation request buttons 152, unit purchase prices 154, images of the units, features, videos, and 3D digital models of the units. If there are customizations for the units of real estate such as finishings and upgrades, then real estate inventory management system 10 computes and provides, to the client system 14, data identifying the available finishings and upgrades. Customization options such as available finishings and upgrades may also be displayed on the user interface as virtual models or images of the finishings and upgrades. Real estate inventory management system 10 may provide a virtual model of a unit of real estate and virtual models of finishings and upgrades, such as appliances, fixtures and so on, that may be positioned within the virtual model of the unit.

Real estate inventory management system 10 provides computed and recorded data relating to real estate blueprints, floor plans and other particular details in response to receiving a query from client system 14 via a unit link, for example, and provides pertinent information for selecting a desired unit.

Referring back to FIG. 4, at step 214, real estate inventory management system 10 receives a reservation request identifying a unit record of the unit records that are available for sale. Real estate inventory management system 10 receives reservation request from client system 14 to reserve the right to purchase the selected unit of real estate and further receives purchasing data for processing a reservation fee as a deposit for the selected unit of real estate.

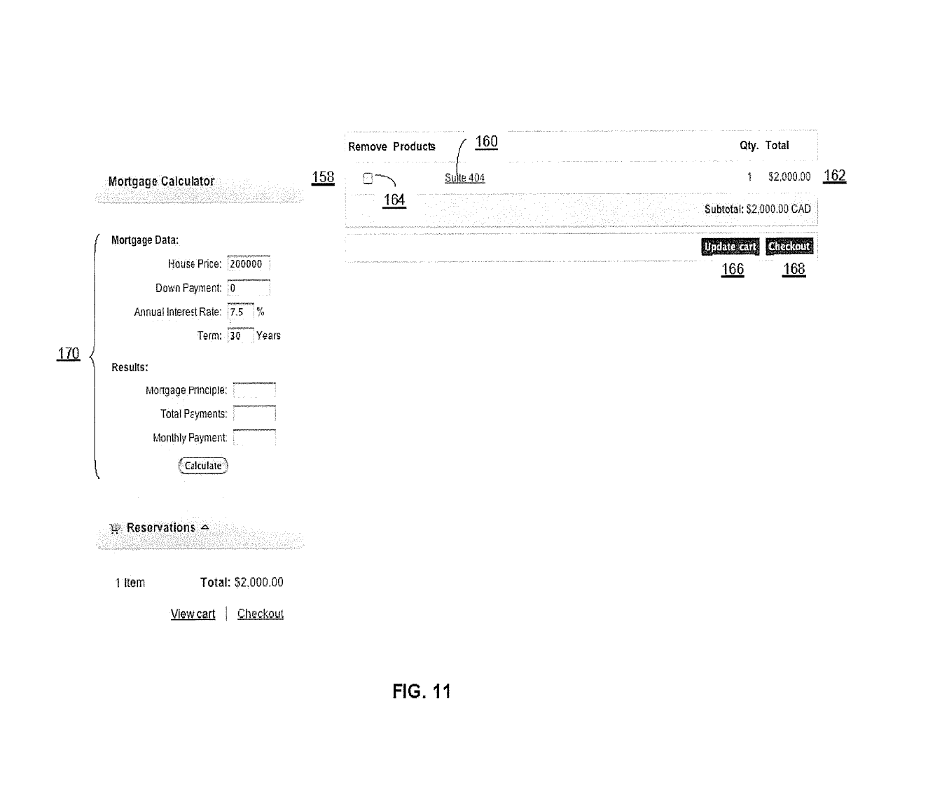

Reference is now made to FIG. 11, which illustrates a sample screen display of a user interface of real estate inventory management system 10 displaying a shopping cart 158 listing the unit of real estate 160 identified in the request along with the reservation fee 162. The user interface provides a remove unit button 164, an update button 166, a mortgage calculator 170, and a checkout button 168 for receiving a request from client system 14 to modify and complete the reservation.

If the reservation request identifies a unit record linked to at least one customization record then real estate inventory management system 10 may further provide customization data related to the unit of real estate to client system 14. As noted herein, real estate inventory management system 10 permits static customization, semi-customization, and full customization alternatives for units of real estate.

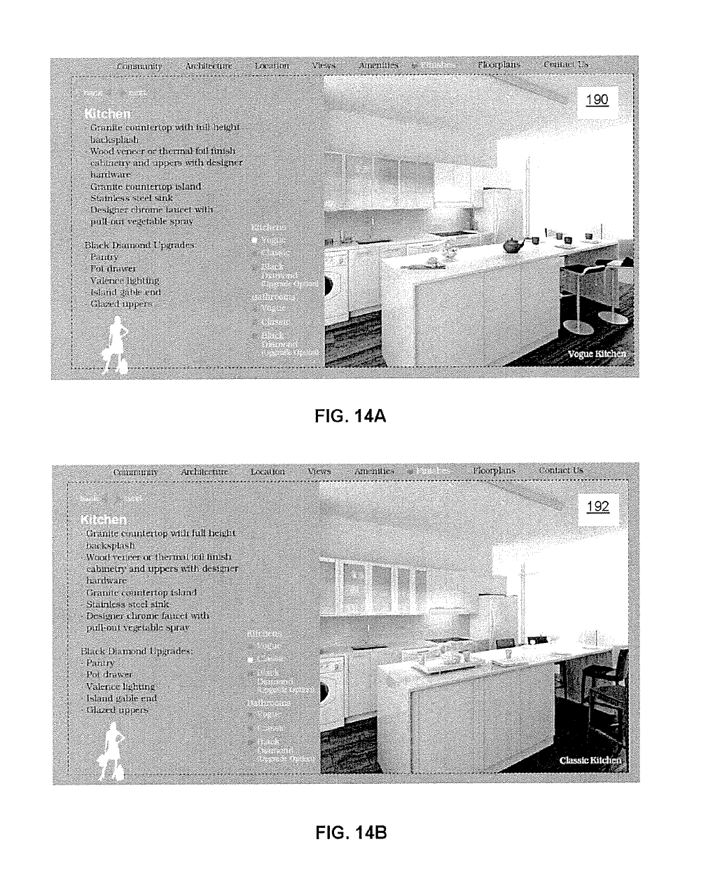

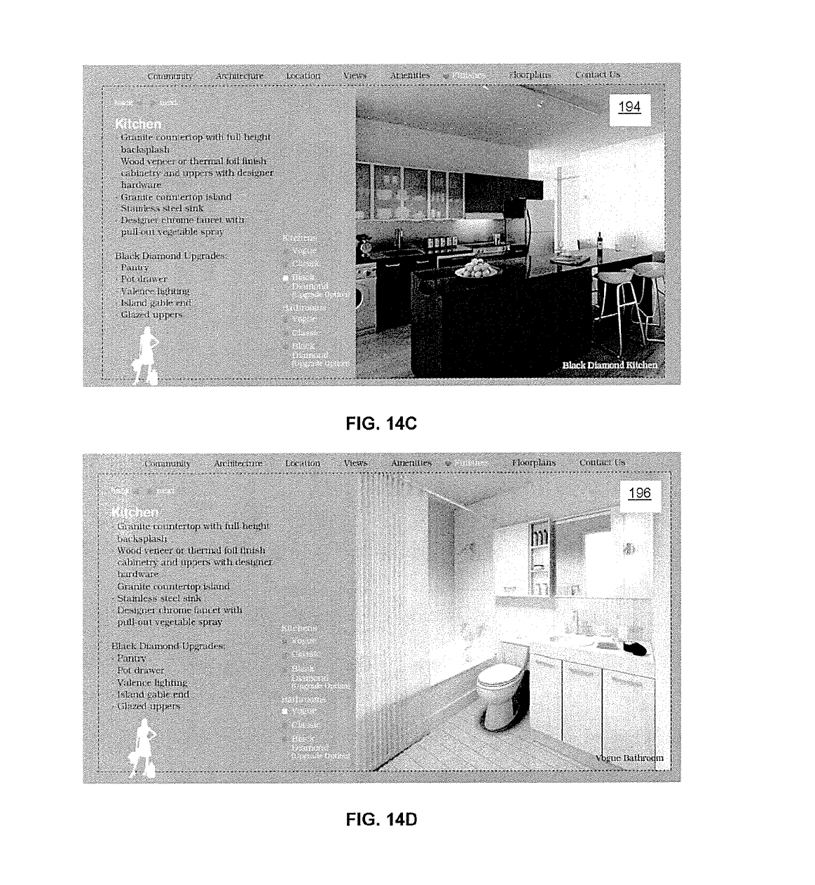

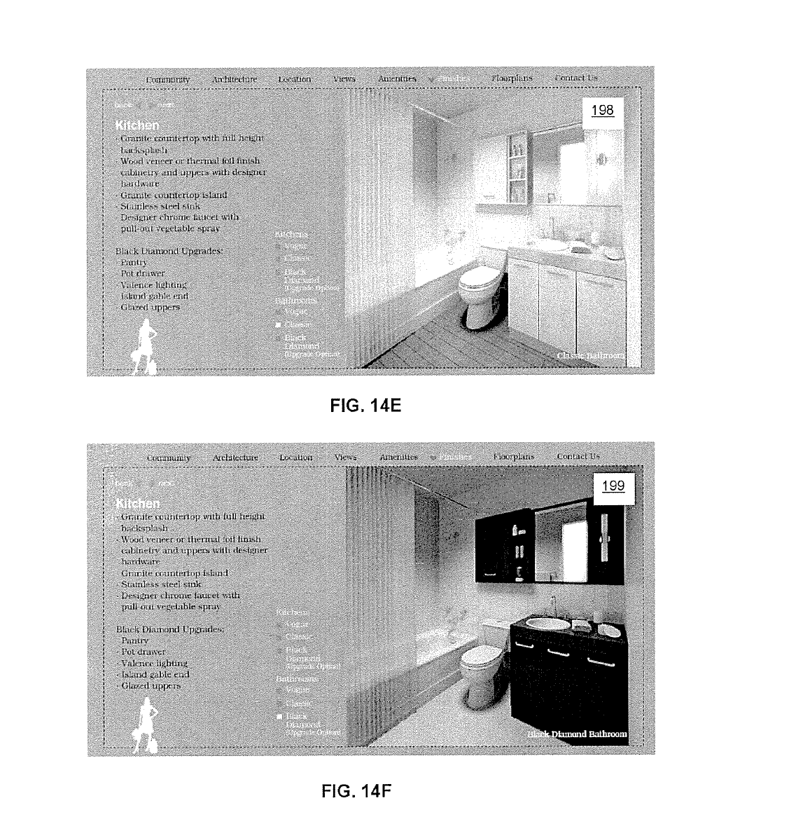

Reference is now made to FIGS. 14A, 14B, 14C, 14D, 14E, and 14F, which illustrate sample screen displays of a user interface of real estate inventory management system 10 providing customization data related to the selected unit of real estate. For example, real estate inventory management system 10 permits static customization options to the buyer 16. FIGS. 14A, 14B, and 14C provide customization data 190, 192, and 194 finishing options for a kitchen of the unit of real estate, such as granite countertops in various colors, backsplash, wood veneers, stainless steel sink, chrome faucet, cabinetry in various colors, pantry, islands, hardware and lighting. FIGS. 14D, 14E, and 14F provide customization data 196, 198, and 199 finishing options for a bathroom of the unit of real estate, such as vanities in various colors, backsplash, wood veneers, stainless steel sink, chrome faucet, cabinetry in various colors, toilet, bathtub, shower, fixtures hardware and lighting.

At step 214, real estate inventory management system 10 may further receive a customization request identifying at least one of the available furnishings and upgrades and store the customization request in the memory, linked to the buyer record and the unit record. Each unit record may include a purchase price field identifying a base price for the unit of real estate and each customization record may identify prices of the available finishings and upgrades. Upon receiving a customization request, real estate inventory management system 10 may calculate a purchase price for the identified unit record using the base price and the price of the available furnishings and upgrades identified in the customization request. Real estate inventory management system 10 may store the purchase price in the memory linked to the buyer record to maintain a relationship between the reserved unit and the buyer 16.

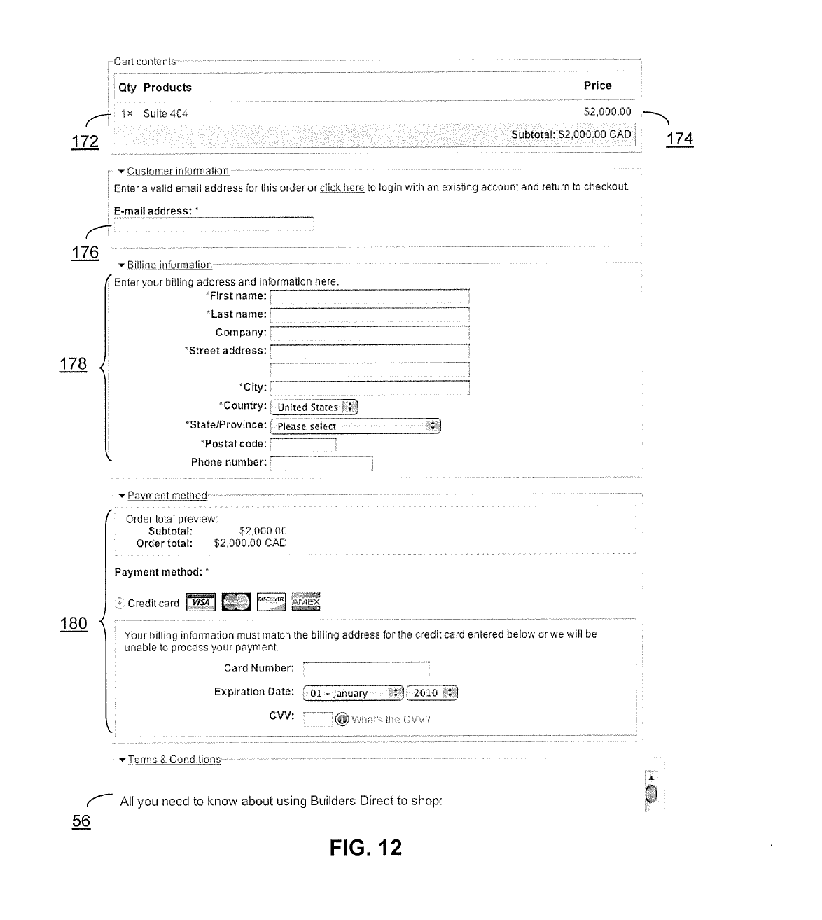

Referring back to FIG. 4, at step 216, real estate inventory management system 10 receives purchasing data for a reservation fee for the identified unit record. Buyer 16 submits purchasing data to pay a reservation fee and reserve the right to purchase to unit of real estate. Reference is now made to FIG. 12, which illustrates a sample screen display of a user interface of real estate inventory management system 10 for receiving purchasing data. The user interface provides the unit of real estate 172 and the reservation fee 174, and receive a buyer email address 176, billing data 178 (name, company, address, phone number), payment data 180, and an acceptance of terms and conditions 182 from client system 14. Upon receiving and confirming the terms and conditions from the client system 14, real estate inventory management system 10 finalizes the purchase by receiving an authorization to process a reservation fee as a deposit in order to legitimately reserve the unit.

Referring back to FIG. 4, at step 218, real estate inventory management system 10 processes the authorization for the deposit in the amount of the reservation fee for the identified unit record using the purchasing data. Real estate inventory management system 10 collects and wires reservation fees to the builder 18, the builder's lawyer or other authorized agent. Real estate inventory management system 10 may also provide an agreement for purchase and sale for the unit of real estate upon receiving payment of the reservation fee. Once the reservation fee has been successfully processed, then real estate inventory management system 10 may deduct an administration fee for use of real estate inventory management system 10 and provide the balance to the builder 18 or authorized agent.

At step 220, upon determining that the deposit for the identified unit record has been successfully processed, real estate inventory management system 10 updates the reservation status of the identified unit record to indicate that the unit of real estate is no longer available for sale or that the availability status is pending subsequent confirmation. In addition, upon determining that the deposit for the identified unit record successfully processed, real estate inventory management system 10 may link the identified unit record to the buyer record to maintain the relationship between the reserved unit of real estate and the buyer 16. This permits real estate inventory management system 10 to maintain an update to date inventory of all available units so it will not receive a subsequent request to reserve the unit of real estate that is already reserved for purchase.

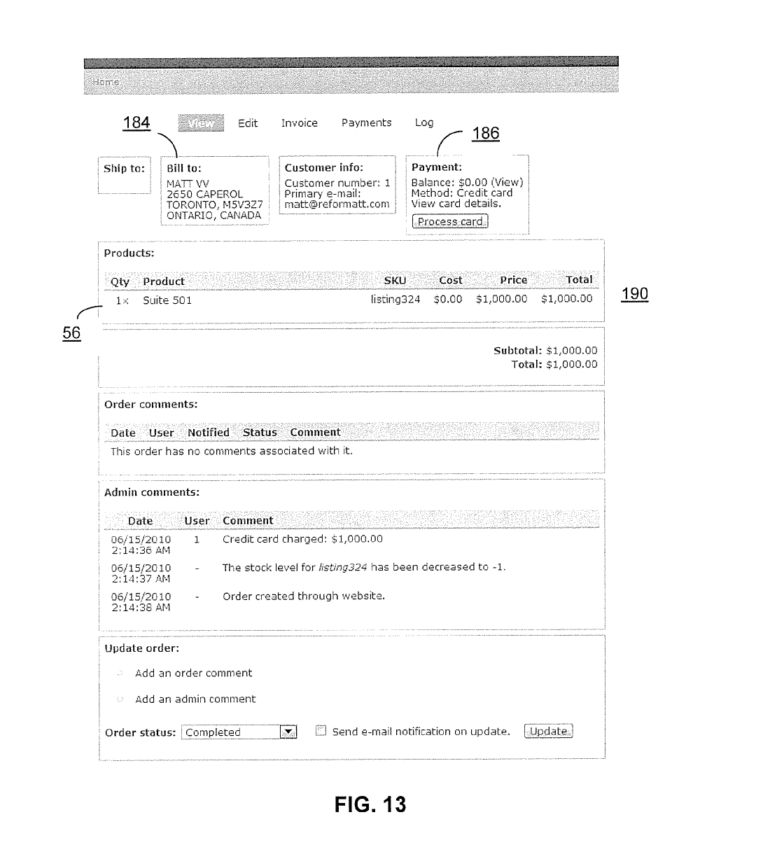

At step 222, real estate inventory management system 10 verifies that the deposit for the identified unit record processed and transmits a deposit confirmation to the builder using the builder identification field of the identified unit record. Real estate inventory management system 10 may deliver to builders 18 the status of each unit within their inventory pool remotely via a mobile device or a client system 14 operated by the builder 18. As noted herein, a unit record may include a builder identification field for storing data related to a builder which real estate inventory management system 10 accesses in order to a transmit deposit confirmation. Reference is now made to FIG. 13, which illustrates a sample screen display of a user interface of real estate inventory management system 10 displaying a notification including buyer data 184, payment data 186, the reserved unit of real estate 188, and the reservation fee 190. Real estate inventory management system 10 will provide a confirmation email to builder 18 that uploaded the reserved unit of real estate. Real estate inventory management system 10 may provide an invitation to the buyer 16 to a finalization meeting to sign the final paperwork. Real estate inventory management system 10 manages unit reservations and verifies all the order details before sending the invitation to the buyer 16 to the sales center to finalize the paperwork. Refunds can also be initiated if the buyer 16 does not comply with the terms and conditions.

Embodiments of the present invention may provide tiered security access capabilities. For example, a centralized set of data may be linked to a builder's record, which staff member's are able to access by logging in via a staff record linked to the builder's record. Each record (builders, site administration, staff, sales representatives) may have an associated level of security clearance and access to determine the scope of data they can access and edit. Depending on their security clearance the user will be able to change unit details such as the floorplan, name of the unit, price, availability (sold firm—after the 10 days cooling period, sold conditionally—within the 10 days, or newly released as the plans become ready—such as upper floors or penthouse units previously unavailable) or simply to view the real-time status of a units availability on or off site.

Table 1 illustrates example classes of the framework architecture of real estate inventory management system 10. The framework architecture includes: a record module (or node module) which permits content to be submitted and records to be created, including project record, builder record, buyer record, unit record, customization record, listing record, and so on; a purchasing module (or cart module) for “checkout” of the selected unit(s) of real estate and receiving the purchase information; a deposit processing module for initiating and processing the purchase information in order to reserve unit(s) of real estate; and a product module for listing records and all related details which can be viewed prior to reservation.

TABLE 1

[symbol]

access [symbol]
actions [symbol]
actions_aid [symbol]
advanced_help_index [symbol]
authmap [symbol]
batch [symbol]
blocks [symbol]
blocks_roles [symbol]
boxes [symbol]
buildersdirect_log [symbol]
ca_predicates [symbol]
cache [symbol]
cache_block [symbol]
cache_content [symbol]
cache_filter [symbol]
cache_form [symbol]
cache_location [symbol]
cache_menu [symbol]
cache_page [symbol]
cache_rules [symbol]
cache_uc_price [symbol]
cache_update [symbol]
cache_views [symbol]
cache_views_data [symbol]
comments [symbol]
content_field_blog_reference [symbol]
content_field_builder_reference [symbol]
content_field_event_video [symbol]
content_field_image_cache [symbol]
content_field_listing_features [symbol]
content_field_project_amenities [symbol]
content_field_project_files [symbol]
content_field_project_images [symbol]
content_field_project_reference [symbol]
content_field_project_sales_hours [symbol]
content_field_project_video [symbol]
content_field_unit_features [symbol]
content_group [symbol]
content_group_fields [symbol]
content_node_field [symbol]
content_node_field_instance [symbol]
content_type_banner [symbol]
content_type_blog [symbol]
content_type_builder [symbol]
content_type_event [symbol]
content_type_listing [symbol]
content_type_partner [symbol]
content_type_product [symbol]
content_type_project [symbol]
content_type_unit [symbol]
date_format_locale [symbol]
date_format_types [symbol]
date_formats [symbol]
devel_queries [symbol]
devel_times [symbol]
files [symbol]
filter_formats [symbol]
filters [symbol]
flood [symbol]
fupload_previewlist [symbol]
fuzzysearch_index [symbol]
fuzzysearch_index_queue [symbol]
history [symbol]
image [symbol]
imagecache_action [symbol]
imagecache_preset [symbol]
location [symbol]
location_instance [symbol]
menu_custom [symbol]
menu_links [symbol]
menu_router [symbol]
node [symbol]
node_access [symbol]
node_comment_statistics [symbol]
node_counter [symbol]
node_revisions [symbol]
node_type [symbol]
nodewords [symbol]
nodewords_custom [symbol]
permission [symbol]
role [symbol]
rules_rules [symbol]
rules_sets [symbol]
search_dataset [symbol]
search_index [symbol]
search_node_links [symbol]
search_total [symbol]
seo_checklist [symbol]
seo_group [symbol]
sessions [symbol]
simplenews_mail_spool [symbol]
simplenews_newsletters [symbol]
simplenews_snid_tid [symbol]
simplenews_subscriptions [symbol]
system [symbol]
term_data [symbol]
term_hierarchy [symbol]
term_node [symbol]
term_relation [symbol]
term_synonym [symbol]
trigger_assignments [symbol]
uc_cart_products [symbol]
uc_countries [symbol]
uc_node_checkout_order_products [symbol]
uc_node_checkout_types [symbol]
uc_order_admin_comments [symbol]
uc_order_comments [symbol]
uc_order_line_items [symbol]
uc_order_log [symbol]
uc_order_products [symbol]
uc_order_statuses [symbol]
uc_orders [symbol]
uc_payment_paypal_ipn [symbol]
uc_payment_receipts [symbol]
uc_power_tools [symbol]
uc_product_classes [symbol]
uc_product_features [symbol]
uc_product_stock [symbol]
uc_products [symbol]
uc_store_footers [symbol]
uc_zones [symbol]
url_alias [symbol]
users [symbol]
users_roles [symbol]
variable [symbol]
views_display [symbol]
views_object_cache [symbol]
views_view [symbol]
vocabulary [symbol]
vocabulary_node_types [symbol]
watchdog [symbol]
webform [symbol]
webform_block [symbol]
webform_component [symbol]
webform_roles [symbol]
webform_submissions [symbol]
webform_submitted_data [symbol]
wysiwyg [symbol]
zipcodes

The record module may also be referred to as a node module, where a node identifies content maintained by real estate inventory management system 10. The node module allows content to be submitted to real estate inventory management system 10. Modules and scripts may programmatically submit nodes using API function calls. The node module manages content on e.g. a website for real estate inventory management system 10, and may store all posts as a “node”, regardless of node type. A function call returns a list of all available node types. New node types may be added saved, and deleted. A user can set the value and default values for a node type. A user can update all nodes of one type to be another type.

In addition to basic publishing settings, including whether the post has been published, promoted to the website front page, or should remain present (or sticky) at the top of lists, the node module also records basic information about the author of a post. Optional revision control over edits is available. For additional functionality, the node module may be extended by other modules. Nodes may be also validated to check for errors, such as for example, to make sure that a description of a project has a minimum number of words and to ensure that the author of a post is a valid user.

Though each post on the website may be a node, each post is also of a particular content type. Examples of content types are used to define the characteristics of a post, including the title and description of the fields displayed on its add and edit pages. Each content type may have different default settings for publishing options and other workflow controls. Example content types are story, page, banner, blog, builder, event, listing, project, unit, partner, product, and buyer. A content types page may be used to add new or edit existing content types. Additional content types also become available as additional core, contributed and custom modules are configured. A content type page may provide a list of all the content types on the website. To create a new content type, real estate inventory management system 10 receives the human-readable name, the machine-readable name, and all other relevant fields. Once created, users of the website will be able to create posts that are instances of this content type.

Content types may have defined content fields and instances thereof. Examples include blog reference, builder reference, availability reference, event video, image cache, unit features, project features, project amenities, project files, project images, unit images, project reference, unit reference, project sales hours, project video.

Content types may also belong to content groups, where each group has corresponding content fields. For example, units may belong to a project group.

The administrative content page allows an administrative user to review and to manage website content. The post settings page sets certain options for the display of posts. The node module makes a number of permissions available for each content type, which may be set by role on the permissions page.

Node revisions track differences between multiple versions of a post. A function call may return a list of all node revisions. A master log maintains a record of all revisions to the website. Nodes may be added and deleted. Nodes are associated with display attributes which define the display of a given node. A node may be defined as a structured array of content containing the individual elements of the node.

Security settings control permissions to make revisions to posts, via node access. The node access system determines who can do what to which nodes. In determining access rights for a node, node_access first checks whether the user has administer permission. Such users have unrestricted access to all nodes. Then the node module's access function is called, and a TRUE or FALSE return value will grant or deny access. This allows, for example, the blog module to always grant access to the blog author. If node module does not intervene (returns NULL), then the node_access table is used to determine access. All node access modules are queried using node_grants to assemble a list of grant IDs for the user. This list is compared against the table. If any row contains the node ID in question (or 0, which may stand for “all nodes”), one of the grant IDs returned, and a value of TRUE for the operation in question, then access is granted. Note that this table is a list of grants; any matching row is sufficient to grant access to the node. In node listings, the process above is followed except that the access function is not called on each node for performance reasons and for proper functioning of the pager system. Access levels may be defined by an administrative user for example. A user may also be assigned ownership of a node.

Real estate inventory management system 10 searches the website data for content and a ranking is used to order the results, where each node has an associated node rank computed using ranking expressions and weights associated with e.g. keyword relevance. Real estate inventory management system 10 may receive comments on content depending on the comment mode for the node, and the comments and data regarding the comments are stored as node comment statistics.

Content on the websites may be subscribed to via RSS feeds, for example. A function permits generation of RSS from a set of nodes.

The purchasing module checkouts the selected unit(s) of real estate and receive the purchase information, and may also be referred to as a cart module. The cart system module functions like an e-commerce cart at its base level and handles the cart display, adding items to a cart, and checking out. The module permits the cart, products (units), and checkout to be extensible. Real estate inventory management system 10 permits configurations, display and modification of the cart settings, including display settings, address field, and checkout settings. For example, checkout receives a reservation request for the units in the shopping cart, and displays and modifies the units in the shopping cart before reservation. Upon completion of a purchase (e.g. payment of reservation fee), confirmation and purchase details may be provided including an order number, an account number and a link to continue shopping. Real estate inventory management system 10 displays available units of real estate, the purchasing module permits real estate inventory management system 10 to receive a request to add units to their cart and check out. The cart receives payment details including a billing address, buyer information and prompting the buyer to open an account with a valid username and password.

The deposit processing module initiates, processes, and verifies the purchase information in order to reserve unit(s) of real estate by interacting with payment gateway 22. The deposit processing module can initiate a secure transaction using encryption, digital signatures, firewalls, passwords (e.g. Verified by Visa™) and the like. The purchase information may include a credit card number, security code and expiry date, and the deposit processing module processes the credit card transaction. The deposit processing module validates the received purchase information to ensure it is in the proper format, and so on. The deposit processing module can interact with payment gateway 22 using API function calls and the like. The deposit processing module can provide a notification indicating that the reservation fee processed successfully or whether the verification failed and that the reservation fee was not processed. The deposit processing module can also process a pre-authorization using the purchasing information.

The product module lists reserved unit and all related details which can be viewed prior to reservation. Real estate inventory management system 10 interacts with the product module to configure how the units will be displayed and what details will be displayed. The product module permits configurations and updates to unit and project settings, including title, images, availability, reservation fee, dimensions, and other details. The product module enables defining of classes, records, and associated fields and validate received input data.

Examples embodying, aspects and features of the present invention have been described here by way of example only. Modifications and variations may be made to these exemplary embodiments without departing from the spirit and scope of the invention, which is limited only by the appended claims.

We claim:

1. A method of operating a real estate inventory management system, the real estate inventory management system being configured to interface with a first client system, said method comprising:
establishing a database of unit records, said database including at least one unit record associated with a unit of real estate, each said unit record having an identifier for the unit of real estate associated therewith, each said unit record having a reservation status field indicating whether the unit of real estate associated therewith is available for sale;
storing the database in a memory;
identifying in the database a subset of unit records, said subset including at least a first unit record having a reservation status field indicating that the unit of real estate associated therewith is available for sale;
providing, to the first client system, data identifying said subset of unit records;
receiving, from the first client system, a reservation request identifying a first selected unit record of said subset of unit records, said first selected unit record having a reservation status field indicating that the unit of real estate associated therewith is available for sale;
receiving, from the first client system, purchasing data for a reservation fee for the unit of real estate associated with said first selected unit record;
receiving, from the first client system, authorization to obtain a deposit in the amount of the reservation fee for the unit of real estate associated with the first selected unit record;
processing said authorization using the purchasing data to obtain the deposit; and
verifying that the deposit for the unit of real estate associated with said first selected unit record processed;
updating the reservation status field of said first selected unit record to indicate that the unit of real estate associated therewith is not available for sale.

2. The method of operating a real estate inventory management system of claim 1 further comprising:
establishing project records, said project records including at least one project record associated with a real estate project, each said real estate project including at least one unit of real estate, each said project record having an identifier for the real estate project associated therewith;
storing the project records in the memory;
linking, in the memory, each real estate project record to at least one unit record associated with a unit of real estate included in said real estate project associated with said real estate project record;
providing, to a client system, data identifying one or more real estate projects associated with project records;
receiving a request identifying a real estate project associated with a first selected project record;
providing, to the client system, data identifying one or more unit records linked to the first selected project record.

3. The method of operating a real estate inventory management system of claim 1 wherein each unit record includes a builder identification field for storing data related to a builder, and wherein the method further comprises:
transmitting a deposit confirmation to the builder using the builder identification field of the first selected unit record.

4. The method of operating a real estate inventory management system of claim 1 further comprising:
establishing customization records identifying available finishings and upgrades for units of real estate associated with unit records;
storing the customization records in the memory;
linking said first one unit record to at least one customization record;
providing, to the client system, data identifying the available finishings and upgrades of said customization record;
receiving a customization request identifying at least one of the available furnishings and upgrades; and
storing the customization request in the memory.

5. The method of operating a real estate inventory management system of claim 4, each said unit record includes a purchase price field identifying a base price for the unit of real estate, and wherein each customization record includes a price field identifying prices of the available finishings and upgrades, and wherein the method further comprises:
calculating a purchase price for the first selected unit record using the base price and the price of the at least one of the available furnishings and upgrades identified in the customization request; and
storing the purchase price in the memory.

6. The method of operating a real estate inventory management system of claim 1 further comprising:
receiving a request to add a unit of real estate, said request including data related to the unit of real estate;
generating a unit record for the unit of real estate, said unit record including data from the request to add the unit of real estate; and
storing the unit record in the database in the memory.

7. The method of operating a real estate inventory management system of claim 2 further comprising:
receiving a request to add a real estate project, said request including data related to the real estate project;
generating a real estate project record for the real estate project, said real estate project record including the data related to the real estate project of the request; and
storing said real estate project record in the memory.

8. The method of operating a real estate inventory management system of claim 7 further comprising:
receiving a request to add a unit of real estate to the real estate project, said request including data identifying said unit of real estate;
generating a unit record for said unit of real estate, said unit record including data from the request to add the unit of real estate to the project;
storing said unit record in the memory; and
linking the project record to the unit record in the memory.

9. The method of operating a real estate inventory management system of claim 1 further comprising:
receiving a registration request from a builder, said request including data identifying the builder;
linking the data identifying the builder to at least one of the unit records in the memory.

10. The method of operating a real estate inventory management system of claim 9 further comprising:
receiving a request to add a unit of real estate from the builder, said request including data related to the unit of real estate;
generating a unit record for said unit of real estate, said unit record including the data related to the unit of real estate and a builder identification field storing the data identifying the builder; and
storing the unit record in the memory.

11. The method of operating a real estate inventory management system of claim 1, wherein the reservation request is received from a buyer and wherein the method further comprises:
receiving a registration request from the buyer including data identifying the buyer; and
linking the first selected unit record to the data identifying the buyer.

12. A system for real estate inventory management comprising:
a database of unit records, said database including at least one unit record associated with a unit of real estate, each said unit record having an identifier for the unit of real estate associated therewith, each said unit record having a reservation status field indicating whether the unit of real estate associated therewith is available for sale;
a memory configured to store the database;
a unit management module configured to provide, to a client system, data identifying said subset of unit records;
a reservation request module configured to receive, from the client system, a reservation request identifying a first selected unit record of the subset of unit records, said first selected unit record having a reservation status field indicating that the unit of real estate associated therewith is available for sale;
a reservation purchasing module configured to receive, from the client system, purchasing data for a reservation fee for the unit of real estate associated with the first selected unit record, and authorization to obtain a deposit in the amount of the reservation fee for the unit of real estate associated with the first selected unit record;
a deposit processing module configured to process said authorization using the purchasing data to obtain the deposit and to verify that the deposit for the unit of real estate associated with the first selected unit record processed; and
said unit management module is further configured to update the reservation status field of the first selected unit record to indicate that the unit of real estate associated therewith is not available for sale.

13. The system for real estate inventory management of claim 12, said database including project records, said project records including at least one project record associated with a real estate project, each said real estate project including at least one unit of real estate, each said project record having an identifier for the real estate project associated therewith; said memory is further configured to store each real estate project record to at least one unit record associated with a unit of real estate included in said real estate project associated with said real estate project record; and said system further comprises:
a project management module configured to:
provide, to a client system, data identifying one or more real estate projects associated with project records;
receive a request identifying a real estate project associated with a first selected project record;
provide, to the client system, data identifying one or more unit records linked to the first selected project record.

14. The system for real estate inventory management of claim 12, each said unit record comprises a builder identification field for storing data related to a builder, and wherein the system further comprises:
a notification module configured to transmit a deposit confirmation to the builder using the builder identification field of the first selected unit record.

15. The system for real estate inventory management of claim 12 further comprising:
a customization module configured to:
store customization records identifying available finishings and upgrades for units of real estate, and link at least one unit record of the one or more unit records to at least one customization record;
provide, to the client system, data identifying the available finishings and upgrades of at least one customization record;
receive, from the client system, a customization request identifying at least one of the available furnishings and upgrades;
store the customization request; and
wherein the reservation request module is further configured to receive a reservation request identifying a unit record linked to at least one customization record.

16. The system for real estate inventory management of claim 15 wherein each unit record includes a purchase price field identifying a base price for the unit of real estate, and wherein each customization record identifies prices of the available finishings and upgrades, and wherein the system further comprises:
a purchase price calculation module configured to calculate a purchase price for the identified unit record using the base price and the price of the at least one of the available furnishings and upgrades identified in the customization request, and store the purchase price in the memory.

17. The system for real estate inventory management of claim 1 wherein the unit management module is further configured to:
receive a request to add a unit, said request including data related to the unit of real estate;
generate a unit record for the unit, said unit record including data from the request to add the unit of real estate; and
store the unit record in the memory.

18. The system for real estate inventory management of claim 13 wherein the real estate project management module is further configured to:
receive a request to add a real estate project, said request including data related to the real estate project;
generate a real estate project record for the project, said project record including the data related to the real estate project of the request; and
store the real estate project record in the memory.

19. The system for real estate inventory management of claim 18 wherein the unit management module is further configured to:
receive a request to add a unit of real estate to the real estate project, said request including data identifying the unit of real estate;
generate a unit record for the unit of real estate, said unit record including data from the request to add the unit of real estate to the project;
store the unit record in the memory; and
link the project record to the unit record in the memory.

20. The system for real estate inventory management of claim 12 further comprising a registration module configured to:
receive a registration request from a builder comprising data identifying the builder; and
link the data identifying the builder to at least one of the unit records in the memory.

21. The system for real estate inventory management of claim 20 wherein the unit management module is further configured to:
receive a request to add a unit of real estate from the builder, said request including data related to the unit of real estate;
generate a unit record for the unit, said unit record including data from the request to add the unit of real estate and a builder identification field for storing data identifying the builder; and
store the unit record in the memory.

22. The system for real estate inventory management of claim 12, wherein the reservation request is received from a buyer and wherein the system further comprises a registration module configured to:
receive a registration request from the buyer comprising data identifying the buyer; and
link the first selected unit record to the data identifying the buyer.

23. The system for real estate inventory management of claim 12, said units of real estate include units of pre-construction real estate.

24. The method for real estate inventory management of claim 1, said units of real estate include units of pre-construction real estate.
